(19) United States
(12) Patent Application Publication
(10) Pub. No.: US 2024/0250708 A1
(43) Pub. Date: Jul. 25, 2024

(54) CASE FOR FOLDABLE PORTABLE ELECTRONIC DEVICES

(71) Applicant: PopSockets LLC, Boulder, CO (US)

(72) Inventors: Lawrence Herman Fong, Boulder, CO (US); Altan Nahum, Boulder, CO (US); Jeff Hartman, Boulder, CO (US)

(21) Appl. No.: 18/563,580

(22) PCT Filed: May 26, 2022
(86) PCT No.: PCT/US22/31094

§ 371 Date: Nov. 22, 2023

Related U.S. Application Data
(60) Provisional application No. 63/193,762, filed on May 27, 2021.

(51) Int. Cl. H04B 1/3888; A45C 11/00; A45C 13/00; A45F 5/00; G06F 1/16; H04M 1/02

(52) U.S. Cl. CPC H04B 1/3888; A45C 11/00; A45C 13/005; A45F 5/00; G06F 1/1626; G06F 1/1641; G06F 1/1681; H04M 1/0214; A45C 2011/002; A45F 2200/0516

(57) ABSTRACT

A case for a foldable portable electronic device includes a first case body half, a second case body half, and a hinge covering structure connecting the first case body half to the second case body half. The hinge covering structure may be configured to cover and protect at least a portion of a hinge of the foldable portable electronic device. The case may be configured to fold along the hinge covering structure from an open position to a folded position.

### FIELD OF THE INVENTION

The present disclosure generally relates to portable electronic devices cases and, more particularly, to cases for foldable portable electronic devices.

### BACKGROUND

Portable electronic devices, such as smart phones, are often housed in protective covers or cases in order to protect the device from damage, facilitate gripping and handling the device, and/or provide a stand for propping the device on a surface. Recently, foldable portable electronic devices have been gaining popularity. Such devices general comprise a hinge attaching opposing sides of a display and along which the foldable portable electronic device is foldable onto itself, much a like a book. Traditional portable electronic device cases are unable to adequately accommodate such a hinge and provide sufficient protection.

Therefore, there is a need for an improved case for foldable portable electronic devices that will protect a foldable portable electronic device, facilitate gripping the device, and/or provide a stand for propping the device on a surface.

### SUMMARY OF THE INVENTION

In one or more embodiments, a case for a foldable portable electronic device comprises a first case body half, a second case body half, and a hinge covering structure connecting the first case body half to the second case body half. The hinge covering structure may be configured to cover and protect at least a portion of a hinge of the foldable portable electronic device. Moreover, the case may be configured to fold along the hinge covering structure from an open position to a folded position.

In certain embodiments, the hinge covering structure is essentially flush with the first case body half and the second case body half when the case is in the open position.

In certain embodiments, the hinge covering structure separates the first case body half and the second case body half by a distance when the case is in the open position.

In one or more embodiments, the first case body half and the second case body are in physical contact when the case is in the open position.

In one or more embodiments, the hinge covering structure is disposed entirely within the first case body half and the second case body half when the case is in the open position.

In one or more embodiments, the first case body half or the second case body half is further configured with a grip accessory. The grip accessory is expandable and collapsible and may be disposed on a slidable platform configured to be moveable along a length of the case.

In one or more embodiments, the hinge covering structure may be configured to fold away from the case in the open position so as to form a stand that maintains the foldable portable electronic device on a surface in an upright or angled position.

In one or more embodiments, the case may comprise a bumper disposed around a periphery of the foldable portable electronic device, where the bumper comprises an interlocking ridge having alternating extensions and recesses that interconnect when the case is in the folded position.

### BRIEF DESCRIPTION OF THE DRAWINGS

The above needs are at least partially met through provision of the portable electronic device accessory described in the following detailed description, particularly when studied in conjunction with the drawings, wherein:

FIGS. 1A-1D illustrate various side views of one or more embodiments of a foldable case for a portable electronic device, configured in accordance with the principles of the invention;

FIGS. 2A-2D illustrate additional side views of one or more embodiments of a foldable case for a portable electronic device, where the case is configured in accordance with the principles of the invention;

FIG. 3 is a perspective rear view of a foldable case for a portable electronic device configured with a grip accessory, where the case is configured in accordance with the principles of the invention;

FIGS. 4A-4C illustrate additional perspective views of a foldable case for a portable electronic device having a flex hinge and also configured with a grip accessory, where the case is configured in accordance with the principles of the invention;

FIGS. 5A-5E illustrate various different views of one or more embodiments of a foldable case for a portable electronic device having an origami-style hinge, where the case is configured in accordance with the principles of the invention;

FIGS. 6A-6D illustrate various different views of one or more embodiments of a foldable case for a portable electronic device having a cylindrical hinge covering structure, where the case is configured in accordance with the principles of the invention;

FIGS. 7A-7C illustrate various different views of one or more embodiments of a foldable case for a portable electronic device having a magnet-based hinge covering structure, where the case is configured in accordance with the principles of the invention;

FIGS. 8A-8E illustrate various different views of one or more embodiments of a foldable case for a portable electronic device, where the case is configured in accordance with the principles of the invention;

FIGS. 9A-9F illustrate various side views of one or more embodiments of a foldable case for a portable electronic device, where the case is configured in accordance with the principles of the invention;

FIGS. 10A-10B illustrate different perspective views of one or more embodiments of a foldable case for a portable electronic device having a slat-style hinge covering structure, where the case is configured in accordance with the principles of the invention;

FIGS. 11A-I IC illustrate various side views of one or more embodiments of a foldable case for a portable electronic device having a slidable hinge covering structure, where the case is configured in accordance with the principles of the invention;

FIGS. 12A-12G illustrate various different views of one or more embodiments of a foldable case for a portable electronic device having a flex hinge covering structure and a grip accessory disposed on a slidable platform, where the case is configured in accordance with the principles of the invention;

FIG. 13 illustrates a various side views of one or more embodiments of a foldable case for a portable electronic device configured as a bumper-and-backing combination in accordance with the principles of the invention;

FIGS. 14A-14B illustrate different views of one or more embodiments of a foldable case for a portable electronic device also configured as a bumper-and-backing combination in accordance with the principles of the invention; and

FIGS. 15A-15D illustrate different views of one or more embodiments of a foldable case for a portable electronic device having an interlocking bumper, where the case is configured in accordance with the principles of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, a case for a foldable portable electronic device is provided that includes a case body, which may be comprised of a two-piece construction having a first half and a second half, and a hinge accommodating structure connecting and/or disposed between the first and second half of the case body. The first half of the case body may be configured to substantially cover a corresponding first half of a foldable portable electronic device, while the second half of the case body may be configured to substantially cover a corresponding second half of a foldable portable electronic device. The hinge accommodating structure connecting and/or disposed therebetween may be configured to substantially cover a hinge connecting the first and second half of the foldable portable electronic device, along which the portable electronic device may be opened and closed in a book-like fashion.

As shown in various figures throughout, it should be appreciated that certain examples of the hinge covering structures may be flush with the corresponding first case body half and the second case body half when the case is in the open position. Depending on the embodiment, flush may mean that the hinge covering structure does not bulge or otherwise have a thicker profile than the respective sides of the case.

In other embodiments, the case for the foldable portable electronic device may additionally include an accessory attached thereto, wherein the accessory may be a grip accessory including an expanding mechanism that is movable relative to the case (and device) between a collapsed configuration and an expanded configuration. The grip accessory may further include a button coupled to the expanding mechanism.

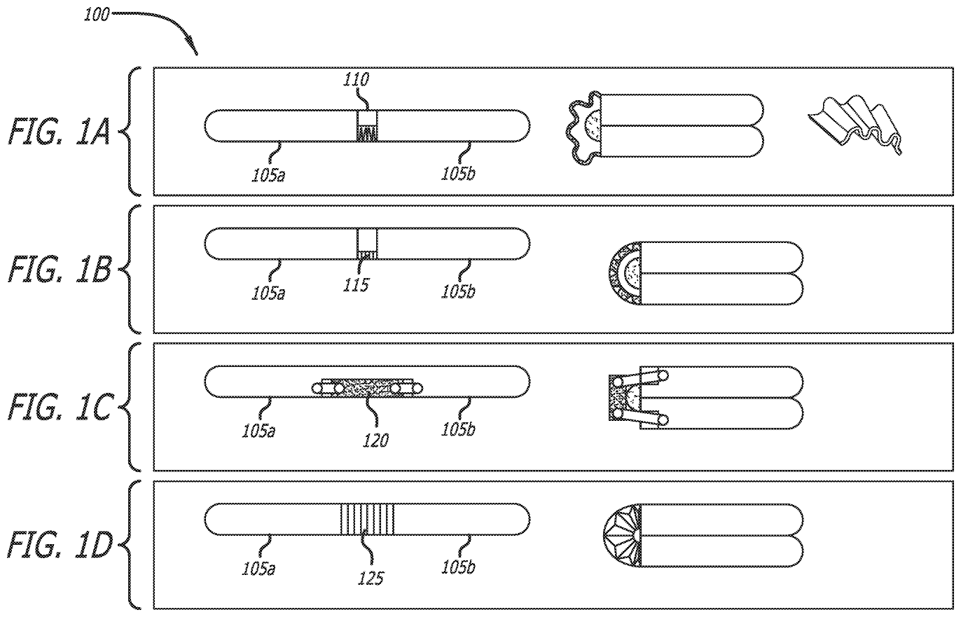

Referring now to FIG. 1A, depicted is a side view of various examples of a case 100 for a foldable portable electronic device configured in accordance with the principles of the invention. As shown, case 100 comprises a first case body half 105a and a second case body half 110b, connected by a hinge covering structure 110. In this embodiment, the hinge covering structure 110 is comprised of a wrinkle band hinge and is configured to enshroud and protect a hinge of the foldable portable electronic device.

The embodiments of FIGS. 1B-1D are similarly comprised of examples of a case 100 having a first case body half 105a and a second case body half 110b, in each instance connected by a hinge covering structure. In FIG. 1B, the hinge covering structure 115 is comprised of a relief cut hinge. In FIG. 1C, the hinge covering structure 120 is comprised of a tensioned middle hinge. In FIG. 1D, the hinge covering structure 125 is comprised of an accordion hinge. For each of FIGS. 1A-1D, both an open position and a folded position are depicted and, in each case, the hinge covering structure is configured to enshroud and protect a hinge of the foldable portable electronic device.

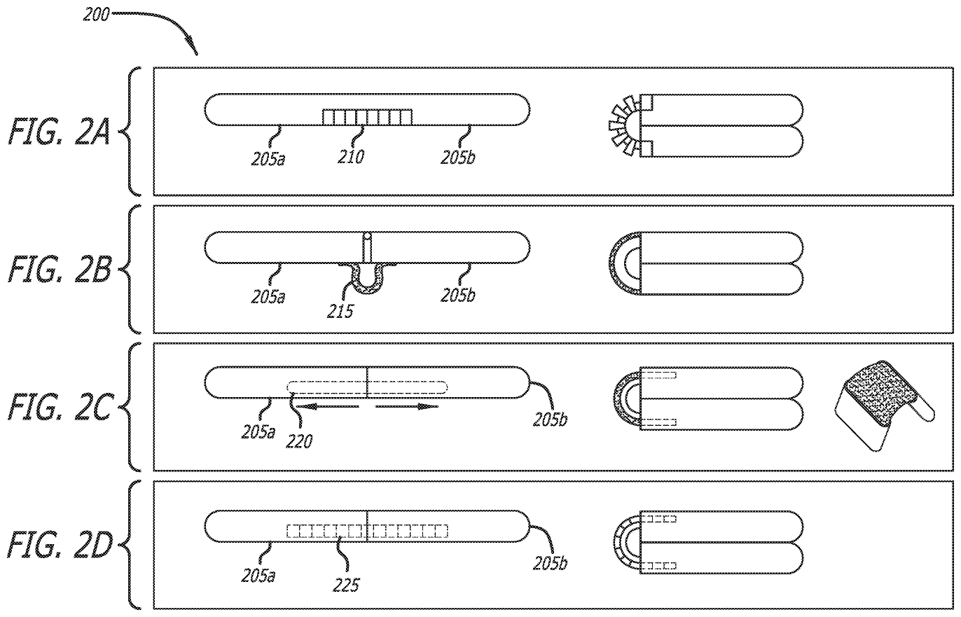

Referring now to FIGS. 2A-2D, depicted are side views of additional examples of a case 200 for a foldable portable electronic device configured in accordance with the principles of the invention. As shown, case 200 comprises a first case body half 205a and a second case body half 210b, connected by a hinge covering structure. In FIG. 2A, the hinge covering structure 210 is comprised of a watchband hinge. In FIG. 2B, the hinge covering structure 215 is comprised of a stretchy-band hinge. In FIG. 2C, the hinge covering structure 220 is comprised of a semi-flexible sheath hinge which is configured to be hidden when the device is unfolded (open). In FIG. 2D, the hinge covering structure 225 is comprised of a segmented sheath hinge which again is configured to be hidden when the device is flattened, as shown. For each of FIGS. 2A-2D, both an open position and a folded position are depicted.

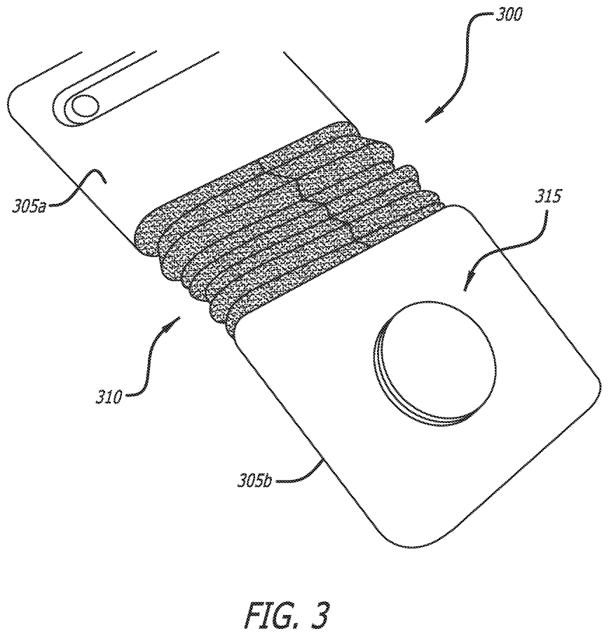

Referring now to FIG. 3, depicted is a perspective view of an additional example of a case 300 for a foldable portable electronic device configured in accordance with the principles of the invention. As shown, case 300 comprises a first case body half 305a and a second case body half 305b, connected by an accordion-style hinge covering structure 310. In addition, in the example of FIG. 3 the second case body half 305b of case 300 is further configured with a grip accessory 315, which may be removably attached or integrally formed with case 300. In certain embodiments, grip accessory 315 may be configured in accordance with the expandable/collapsible structure disclosed in U.S. Pat. No. 8,560,031 and U.S. Publication No. 2018/0288204, which are hereby incorporated by reference in their entirety.

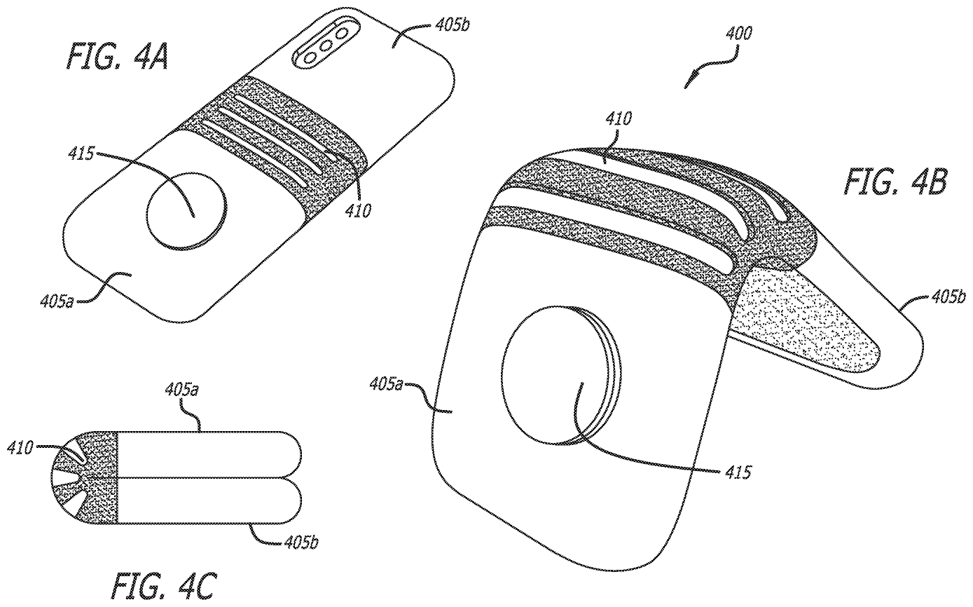

FIGS. 4A-4C depict various views of an additional example of a case 400 for a foldable portable electronic device configured in accordance with the principles of the invention. As shown, case 400 comprises a first case body half 405a and a second case body half 405b, connected by a flex hinge covering structure 410, which may be comprised of a flexible thermoplastic polyurethane material. Like case 300, case 400 is also configured with a grip accessory 415, which may be removably attached or integrally formed with case 400, this time disposed on the first side 405a of case 400.

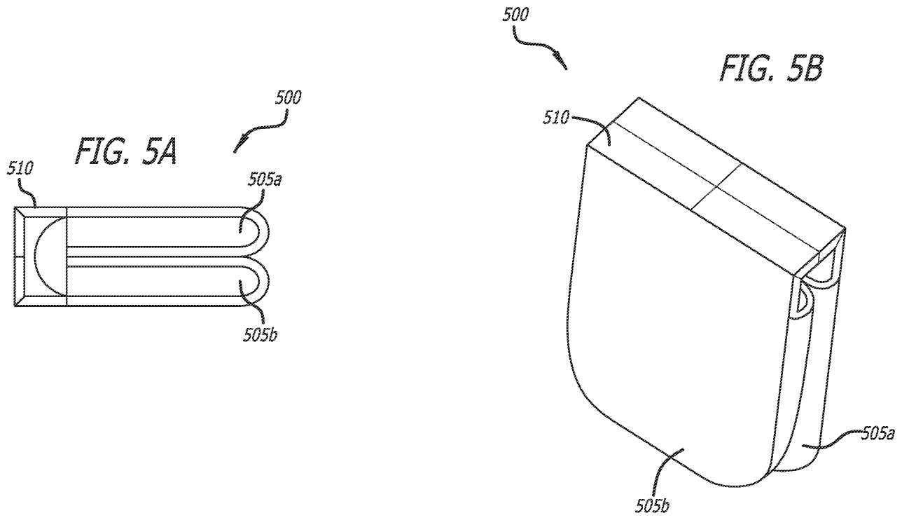

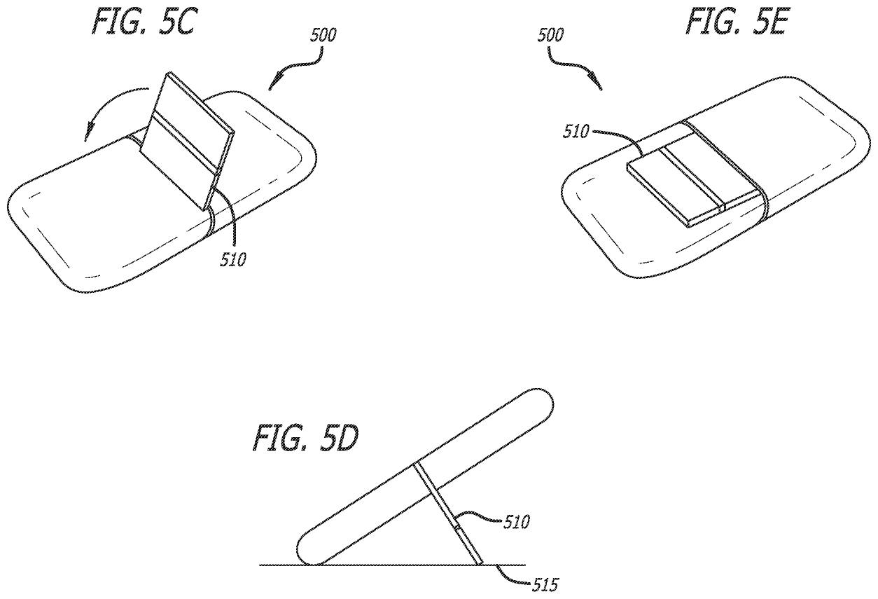

FIGS. 5A-5E depict various views of an additional example of a case 500 for a foldable portable electronic device configured in accordance with the principles of the invention. As shown, case 500 comprises a first case body half 505a and a second case body half 505b, connected by an origami-style hinge covering structure 510. As with the above examples, the origami-style hinge covering structure 510 may be configured to cover and protect a hinge along which the portable electronic device folds, as shown in FIGS. 5A-5B. Moreover, when the case is in an open position, the origami-style hinge covering structure 510 may be fashioned to fold out perpendicular to the back surface of the case 500 (and hence perpendicular to the back of the foldable portable electronic device), as shown in FIG. 5C. As a result, the origami-style hinge covering structure 510 may be used as a stand to erect the foldable portable electronic device on a surface in an upright or angled position, such as surface 515 of FIG. 5D. The origami-style hinge covering structure 510 may also be configured to lay flat against the case 500 when not being used as a stand, as shown in FIG. 5E.

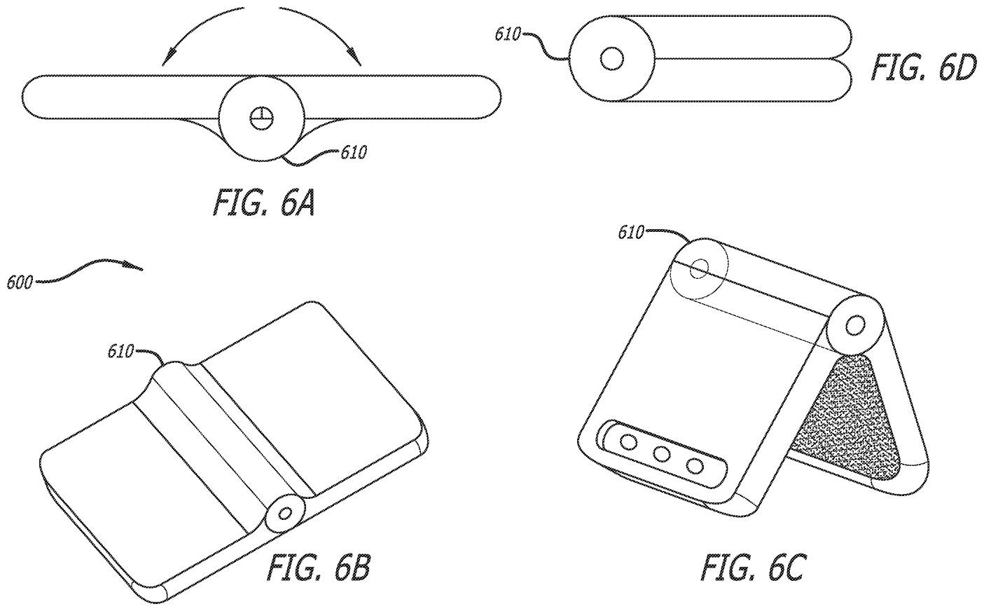

FIGS. 6A-6D depict various views of an additional example of a case 600 for a foldable portable electronic device configured in accordance with the principles of the invention. As shown, case 600 comprises a cylindrical hinge covering structure 610, which may be preferable for enshrouding and protecting larger hinges of foldable the portable electronic devices. Moreover, cylindrical hinge covering structure 610 may accommodate portable electronic devices that comprise left and right foldable sides, as shown in FIG. 6B, or which comprise top and bottom portions that flip open, as shown in FIG. 6C.

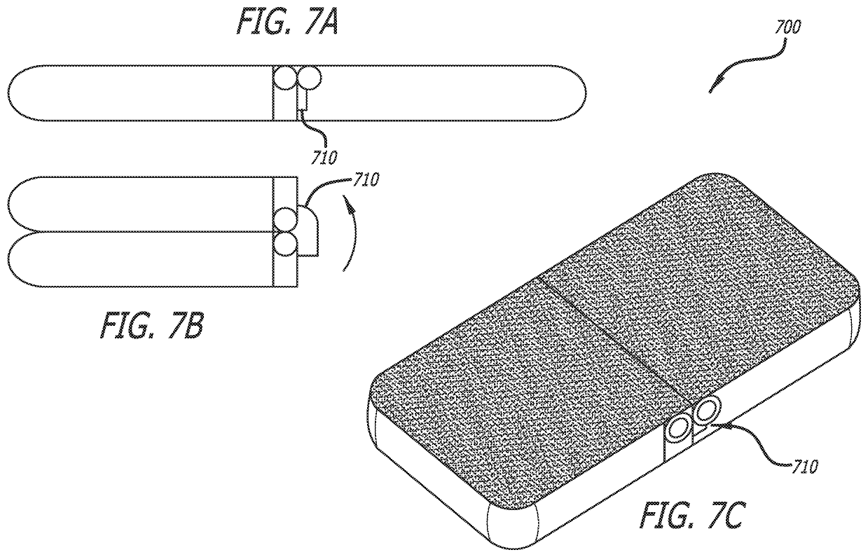

FIGS. 7A-7C depict various views of an additional example of a case 700 for a foldable portable electronic device configured in accordance with the principles of the invention. As shown, case 710 comprises a magnet-based hinge covering structure 710 configured to facilitate keeping the case 700 in the correct position while the portable electronic device is being folded.

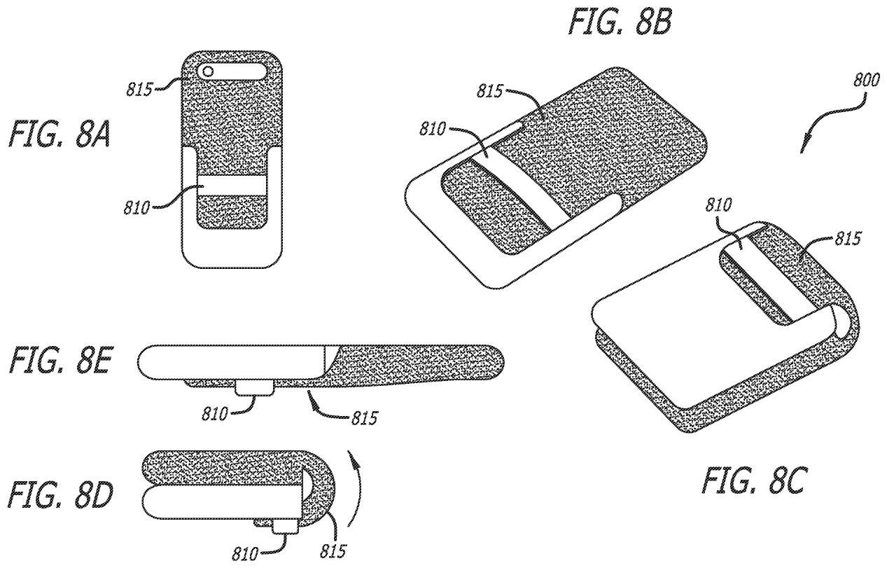

FIGS. 8A-8E depict various views of an additional example of a case 800 for a foldable portable electronic device configured in accordance with the principles of the invention. As shown, case 810 comprises a flexible strap 810 and a fabric back cover 815, which is shown in an open position in FIGS. 8A-8B. In certain embodiments, fabric back cover 815 may be configured to pull through the flexible strap 810, thereby securing the fabric back cover 815 under the flexible strap 810, as shown in FIGS. 8C-8E. In this manner, a hinge of the foldable portable electronic device could be covered and protected by that portion of the fabric back cover 815 that is stretched around and under the strap 810 (see FIG. 8D).

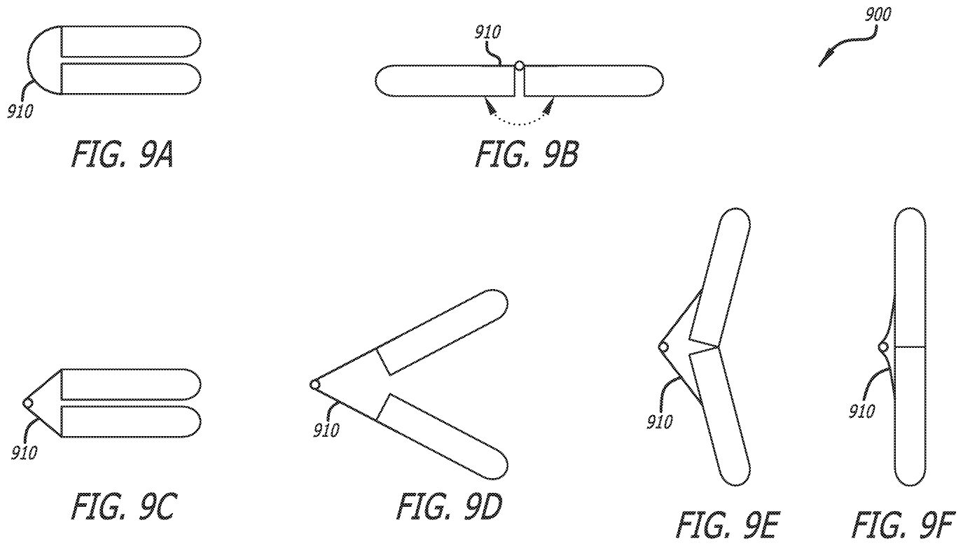

FIGS. 9A-9F depict various views of an additional example of a case 900 for a foldable portable electronic device configured in accordance with the principles of the invention. As shown, case 900 comprises a first case body half and a second case body half connected by a multi-part rigid or semi-rigid hinge covering structure 910. A hinge of the foldable portable electronic device may be covered and protected by the hinge covering structure 910 when the case 900 (and hence the portable electronic device) is in a folded position (FIG. 9A), while the hinge covering structure 910 is configured to lie substantially flat against the case 900 when in an opened position (FIG. 9B). This may be achieved by configured the multi-part rigid or semi-rigid hinge covering structure 910 to extend out from the hinge when in a folded position (FIG. 9C), which then progressively draws towards the hinge/case back as the case 900 (and hence portable electronic device) transitions to an open configuration, the progression of which is shown in FIG. 9D-9F.

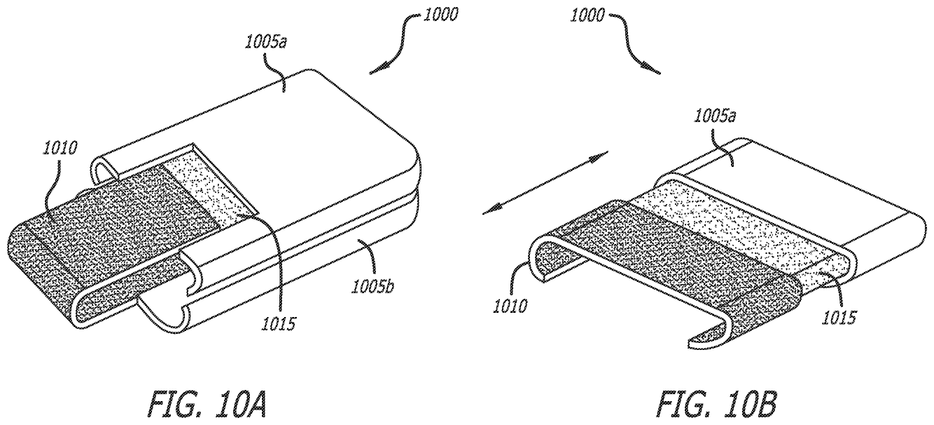

FIGS. 10A-10B depict views of an additional example of a case 1000 for a foldable portable electronic device configured in accordance with the principles of the invention. As shown, case 1000 comprises a first case body half 1005a and a second case body half 1005b connected by a slat-style hinge covering structure 1010. The case 1000 is further configured with a recess 1015 adjacent to each side of the slat-style hinge covering structure 1010 and into which the slat-style hinge covering structure 1010 may travel as the case 1000 moves from a folded position to an open position. FIG. 10A shows an example in which the slat-style hinge covering structure 1010 does not extend completely from edge-to-edge of the case, while FIG. 10B shows an example in which the slat-style hinge covering structure 1010 does extend from edge-to-edge. In either case, the recesses 1015 allow for the ends of the slat-style hinge covering structure 1010 to extend, thereby allowing the slat-style hinge covering structure 1010 to lie substantially flat against the case 1000 when in the open position.

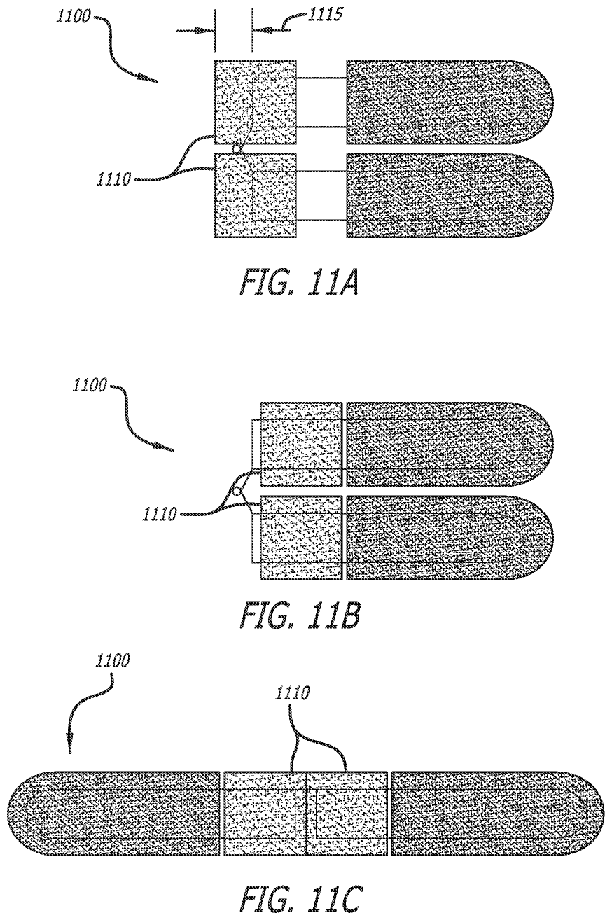

FIGS. 11A-11C depict various side views of an additional example of a case 1100 for a foldable portable electronic device which is similar to case 1000 in that case 1100 also comprises a slidable hinge covering structure 1110. In particular, when case 1100 is in the folded position, as shown in FIGS. 11A and 11B, the slidable hinge covering structure 1110 is configured to slide from a first position (FIG. 11B) to a second position (FIG. 11A), where the second position corresponds to an area 1115 within which a hinge of the portable electronic device is situated. As such, when the slidable hinge covering structure 1110 is in the second position (FIG. 11A) it may function to enshroud and protect the hinge.

The slidable hinge covering structure 1110 may further be moved from the second position (FIG. 11A) to the first position (FIG. 11B) so that the portable electronic device can be placed in an open position (FIG. 11C).

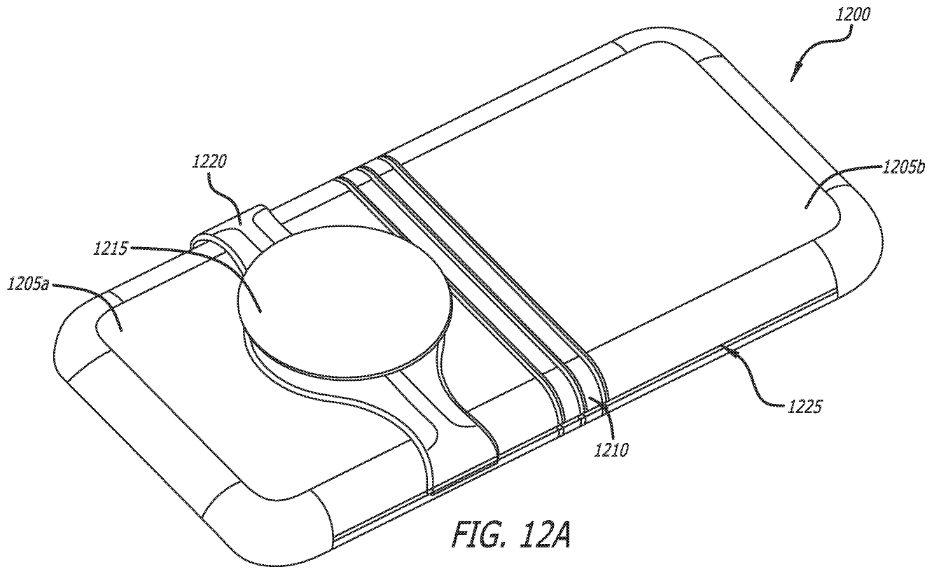

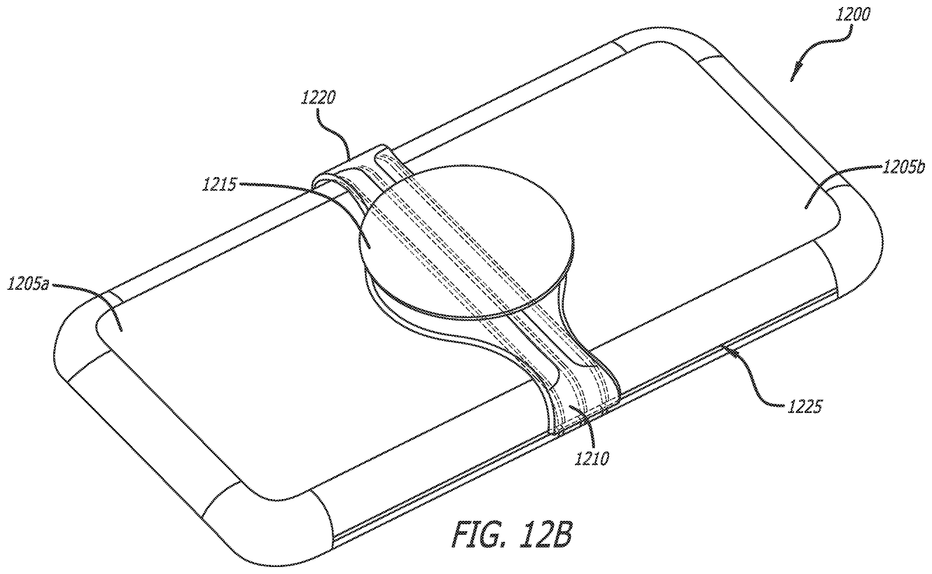

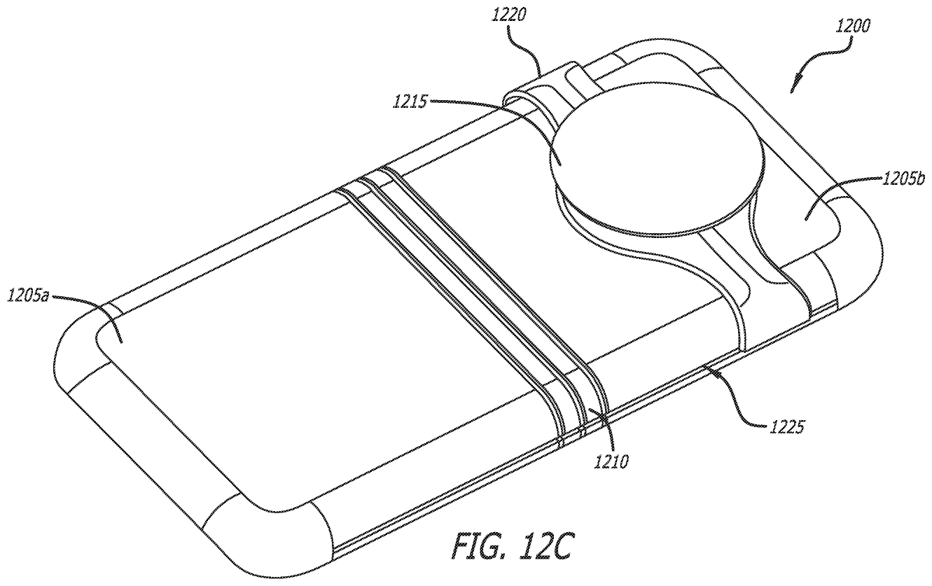

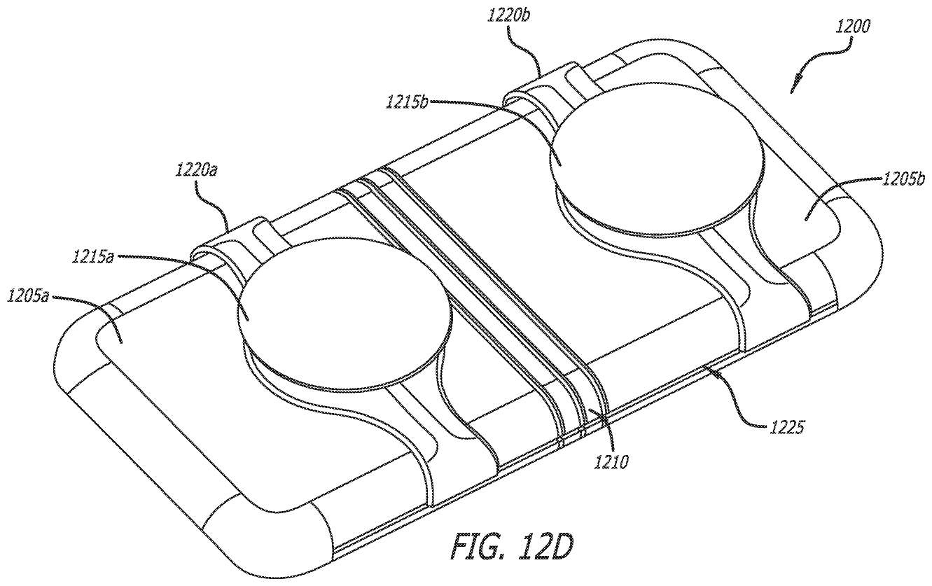

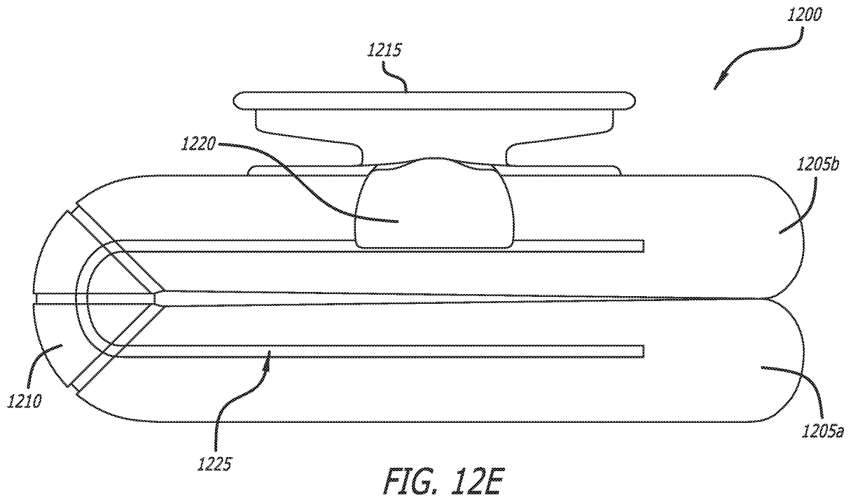

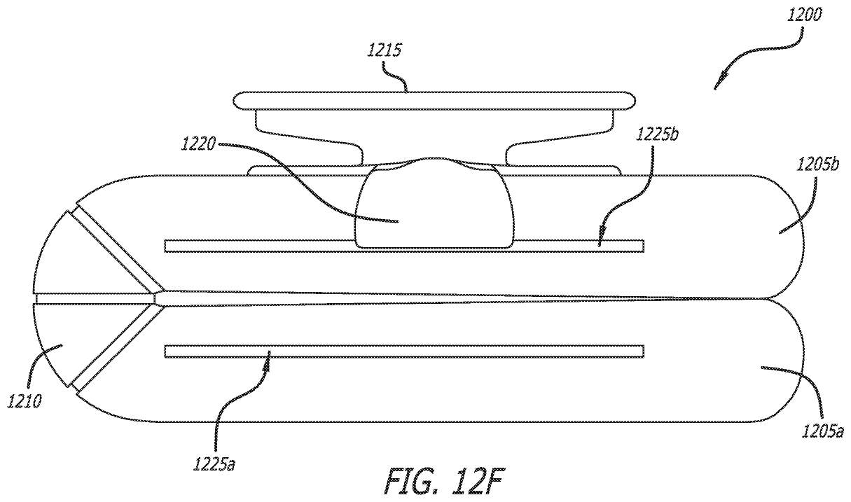

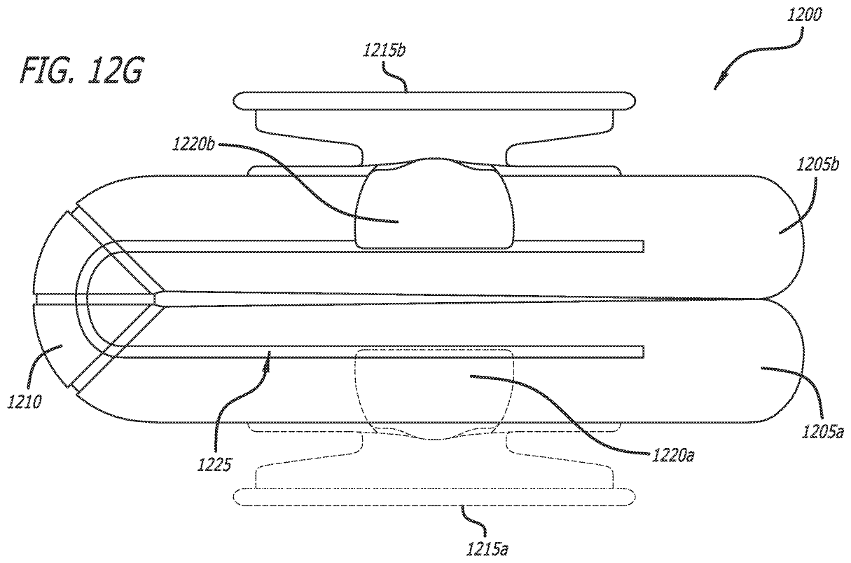

FIGS. 12A-12G depict various views of an additional example of a case 1200 for a foldable portable electronic device configured in accordance with the principles of the invention. As shown, in each of FIGS. 12A-12G the case 1200 comprises a first case body half 1205a and a second case body half 1205b, connected by a flex hinge covering structure 1210, which may be comprised of a flexible thermoplastic polyurethane material with ribs designed to promote bending such that the case 1200 is foldable without having to overly stretch the material that comprises the flex hinge covering structure 1210. Like cases 300 and 400 described above, case 1200 is also configured with a grip accessory 1215, which may be removably attached or integrally formed with case 1200, except that in the example of FIGS. 12A-12G grip accessory 1215 is disposed on a slidable platform 1220 that comprises engaging arms that, generally speaking, engage with and/or secure to an outer edge of the case, such as within a channel/recess 1225 formed along opposing sides of the case 1200, as shown in FIGS. 12A-12G. As shown in FIGS. 12A-12C, the slidable grip accessory 1215 and platform 1220 may be positionable on the first case body half 1205a of the case 1200 (see FIG. 12A), in a middle region of the case 1200 (see FIG. 12B), and on the second case body half 1205b of the case 1200 (see FIG. 12C).

The platform 1220 and, in particular, its engaging arms, may be dimensioned such that they frictionally engage the outer edge of the case 1200 (or within channel/recess 1225) to retain the slidable grip accessory 1215 thereto. In general, the slidable grip accessory 1215 and platform 1220 may be configured in accordance with the disclosure set forth in U.S. application Ser. No. 17/021,535, filed on Sep. 15, 2020, the entirety of which is hereby incorporated by reference.

In some examples of case 1200, the channel/recess 1225 may extend along an uninterrupted length of the sides of the case 1200, such as in FIGS. 12A-12E and 12F, or the channel/recess may be comprises of two or more separated channels/recesses, such as is shown in FIG. 12F in the form of a first channel/recess 1225a and a second channel/recess 1225b.

In one or more of the above examples of case 1200, it should also be appreciated that two (or more) slidable grip accessories/platforms may be attached to the case 1200, such as is shown in FIGS. 12D and 12G, which depict a first slidable grip accessory 1215a and platform 1220a and a second slidable grip accessory 1215b and platform 1220b.

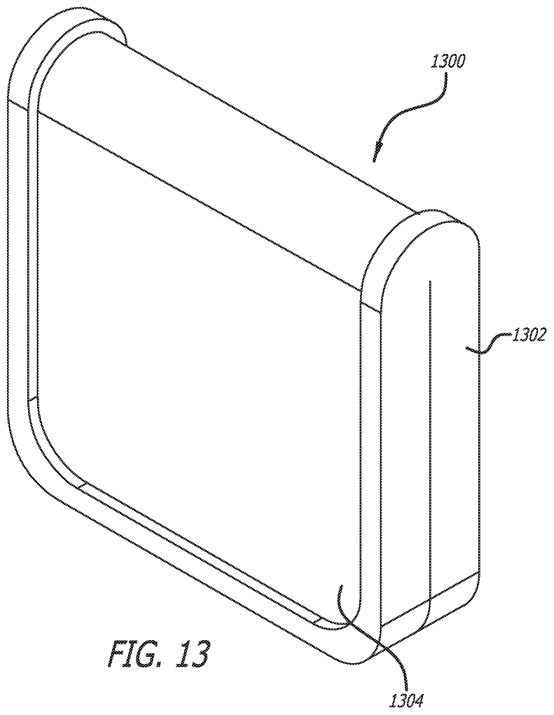

Referring now to FIG. 13, depicted is an additional example of a case 1300 for a foldable portable electronic device configured in accordance with the principles of the invention and depicted in a folded configuration. As with the other examples above, case 1300 comprises a first case body half and a second case body half connected by a flexible middle region. The case 1300 may be configured as a bumper-and-backing combination, where bumper 1302 is disposed around a periphery of a portable electronic device (not shown) and a backing 1304 extends across an entire inner dimension of the bumper 1302, thereby providing a protective backing for a portable electronic device. In another example, however, case 1300 may only comprise bumper 1302 without backing 1304. In this example, a front and back of the portable electronic device would be visible/exposed. Moreover, the flexible middle region of the case 1300 is provided by forming the bumper 1302 and backing 1304 of a flexible/bendable material as opposed to a separate structure or different material.

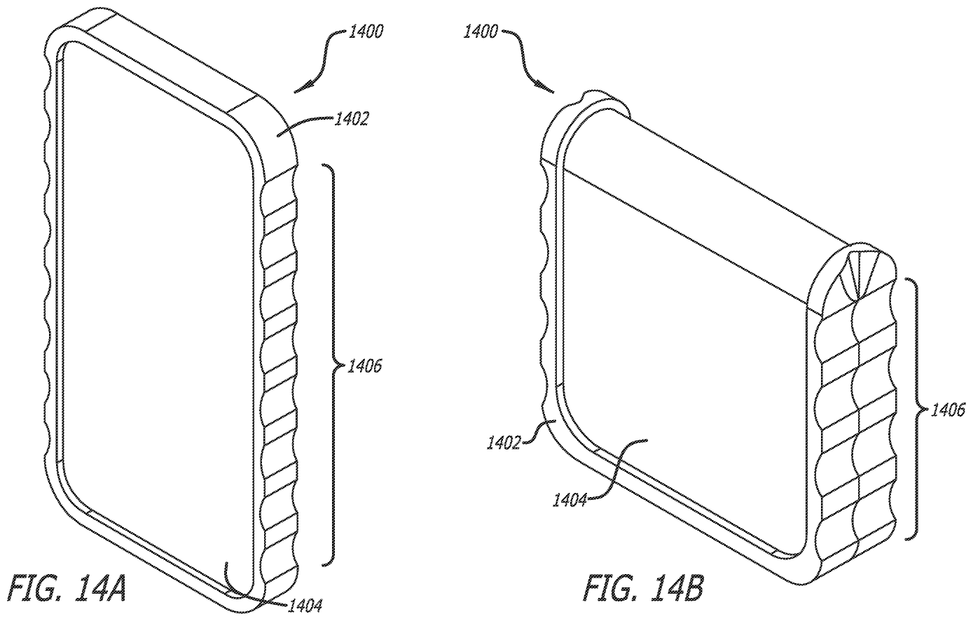

Referring now to FIGS. 14A-14B, depicted is a similar embodiment as case 1300 of FIG. 13, except that the bumper 1402 of case 1400 is configured with a wavy side structure 1406, as shown in FIGS. 14A-14B. It should of course be appreciated that the wavy side structure 1406 may be configured with any combination of contours, which may facilitate a user's ability to grip/hold the case and portable electronic device. Also, as with case 1300, case 1400 may be configured as a bumper-and-backing combination, where bumper 1402 is disposed around a periphery of a portable electronic device (not shown) and a backing 1404 extends across an entire inner dimension of the bumper 1402. Case 1400 may alternatively only comprise bumper 1402 without backing 1404. As with case 1300, the flexible middle region of the case 1400 is provided by forming the bumper 1402 and backing 1404 of a flexible/bendable material as opposed to a separate structure or different material.

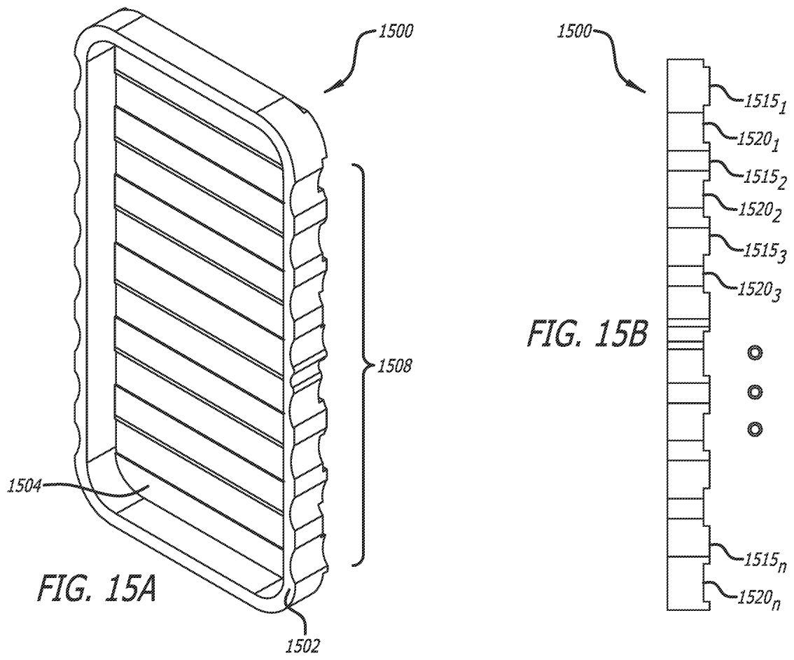

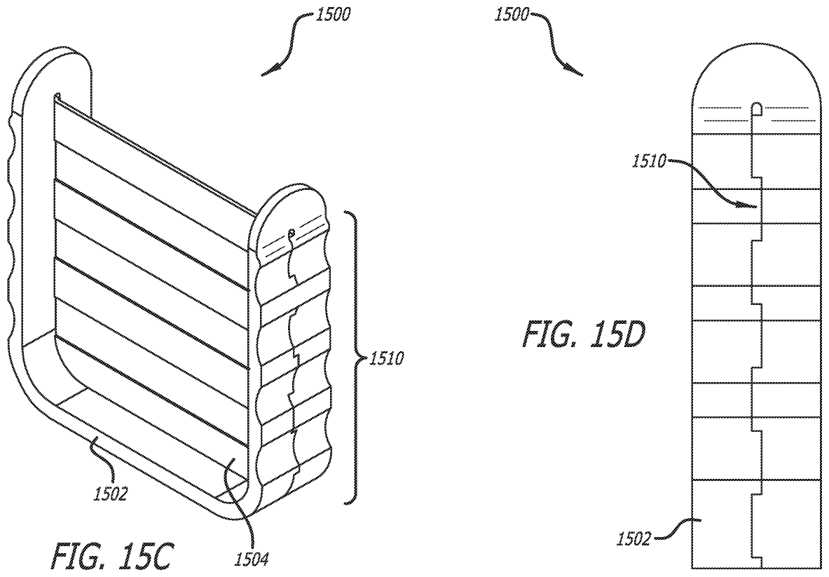

Referring now to FIGS. 15A-15D, depicted is a variation on case 1400 in which, in addition to the bumper 1502 having a wavy side structure, the bumper further comprises an interlocking ridge 1508 disposed along the rear perimeter of case 1500, as best shown in the perspective view of FIG. 15A and the side view of FIG. 15B. Interlocking ridge 1508 is comprises of a series of alternating extensions 1515₁₋ₙ and recesses 1520₁₋ₙ that coordinate and interconnect with each other when the case 1500 is folded onto itself, as can be seen in FIGS. 15C-15D. Specifically, when the two sides of the case 1500 are folded onto each other, the alternating extensions 1515₁₋ₙ and recesses 1520₁₋ₙ are made to interlock, thereby forming an interconnection 1510, as shown in FIGS. 15C-15D. Interconnection 1510 may form a protective seal around the portable electronic device and/or secure the portable electronic device in a folded configuration.

As with case 1400, case 1500 also comprises an optional backing 1504 optional backing 1504 that extends across an entire inner dimension of the bumper 1502. Moreover, a flexible middle region of the case 1500 is provided by the forming the bumper 1502 and backing 1504 of a flexible/bendable material as opposed to a separate structure or different material.

It should further be appreciated that case 1400 having a bumper with the wavy side structure 1406 and/or the interlocking ridge 1508 disposed along the perimeter of case 1500 may be combined with any of the above-described hinge covering structures.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of various embodiments. This description should be read to include one or at least one and the singular also includes the plural unless it is obvious that it is meant otherwise.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

1. A case for a foldable portable electronic device, the case comprising:
a first case body half,
a second case body half, and
a hinge covering structure connecting the first case body half to the second case body half, wherein the hinge covering structure is configured to cover and protect at least a portion of a hinge of the foldable portable electronic device,
wherein the case is configured to fold along the hinge covering structure from an open position to a folded position.

2. The case of claim 1, wherein the hinge covering structure is essentially flush with the first case body half and the second case body half when the case is in the open position.

3. The case of claim 1, wherein the hinge covering structure separates the first case body half and the second case body half by a distance when the case is in the open position.

4. The case of claim 1, wherein the first case body half and the second case body are in physical contact when the case is in the open position.

5. The case of claim 4, wherein the hinge covering structure is disposed entirely within the first case body half and the second case body half when the case is in the open position.

6. The case of claim 1, wherein the first case body half or the second case body half is further configured with a grip accessory.

7. The case of claim 6, wherein the grip accessory is expandable and collapsible.

8. The case of claim 1, wherein the grip accessory is disposed on a slidable platform configured to be moveable along a length of the case.

9. The case of claim 1, wherein the hinge covering structure is configured to fold away from the case in the open position so as to form a stand that maintains the foldable portable electronic device on a surface in an upright or angled position.

10. The case of claim 1, wherein the case comprises a flexible strap and a fabric back cover.

11. The case of claim 1, wherein at least one of the first case body half and the second case body half comprises a recess for receiving the hinge covering structure.

12. The case of claim 1, wherein the case comprises a bumper disposed around a periphery of the foldable portable electronic device, and wherein the bumper comprises an interlocking ridge having alternating extensions and recesses that interconnect when the case is in the folded position.
